(19) United States
(12) Patent Application Publication
(10) Pub. No.: US 2009/0310641 A1
(43) Pub. Date: Dec. 17, 2009

(54) LASER LIGHT SOURCE, PLANAR LIGHT SOURCE, AND LIQUID CRYSTAL DISPLAY DEVICE

(75) Inventor: Syunsuke Kimura, Hyogo (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 12/095,948

(22) PCT Filed: Sep. 6, 2007
(86) PCT No.: PCT/JP2007/067435

§ 371 Date: Jun. 3, 2008

(30) Foreign Application Priority Data
Sep. 7, 2006 (JP) 2006-242439

(51) Int. Cl. H01S 3/08

(52) U.S. Cl. 372/99

(57) ABSTRACT

A laser light source, a surface light source and a liquid crystal display apparatus that can reduce speckle without relying upon mechanical vibrations. The laser light source (100) provides a light emitting element (101) emitting laser light; a deflection element (102) refracting or reflecting the laser light emitted from the light emitting element (101) at a unique angle every wavelength; and a driving circuit (103) driving the light emitting element (101) by driving current where high frequency current is superimposed on direct current. By this means, the light emitting element (101) is driven by the driving current on which high frequency current is superimposed, and the laser light output with multiple wavelength modes is inputted to the deflection element (102). The deflection element (102) emits the incident laser light in different directions in accordance with the wavelengths.

### TECHNICAL FIELD

The present invention relates to a laser light source for a backlight that illuminates the liquid crystal display panel of a liquid crystal display apparatus such as a liquid crystal display projector and a liquid crystal display from the back.

### BACKGROUND ART

For light sources for liquid crystal display projectors, metal halide lamps and mercury lamps are typically used. Moreover, a backlight is placed in the back of a liquid crystal display panel. Light from this backlight makes images outputted onto the display panel visible. For the backlight, a CCFT (Cold Cathode Fluorescent Tube), which is driven by an inverter, is widely used.

In recent years, white LED's (light emitting diodes) and lasers have started being used for an efficient light source that reproduces a wider range of colors and shortens the startup time.

With lasers, polarizing directions are uniform and the basic performance is high including electro-optic conversion efficiency, so that large optical outputs can be produced from small areas. Moreover, lasers can reproduce colors better than LED's. Lasers can construct efficient and high quality systems and therefore provide an ideal point light source.

However, the photons in laser light have a uniform phase and energy and therefore cause severe interference, and so a look at an area illuminated by a laser (hereinafter “illumination area”) would find unevenness in brightness. This phenomenon is referred to as “speckle.”

As one method of reducing speckle, the method of making the optical system containing the laser vibrate mechanically, is known. Patent Document 1 discloses an exposure illumination apparatus that changes the optical path by placing a scatter plate that scatters incident light on the optical path of laser light and making the scatter plate vibrate. This makes it possible to change the distribution of light intensity in illumination areas and reduce speckle.

Patent Document 1: Japanese Patent Application Laid-Open No. HEI 07-297111

### DISCLOSURE OF INVENTION

### Problems to be Solved by the Invention

However, conventional apparatuses making a scatter plate vibrate as described above have a problem of making the apparatus large. Moreover, considering the fatigue of the vibrating part, there is also a problem with the duration of life.

Without relying upon mechanical vibration, speckle can be reduced if the path of laser light can be changed.

It is therefore an object of the present invention to provide a laser light source, a surface light source and a liquid crystal display apparatus that can reduce speckle without relying upon mechanical vibration.

### Means for Solving the Problem

The laser light source of the present invention adopts a configuration including: a light emitting element that emits a laser light; a deflection element that operates relying upon wavelength and that refracts or reflects the laser light emitted from the light emitting element at various angles in accordance with wavelengths; and a driving circuit that drives the light emitting element by a driving current in which a high frequency wave is superimposed on a direct current.

The surface light source of the present invention adopts a configuration including: the laser light source described above and a light guide plate that inputs the laser light outputted from the deflection element and outputs planar light.

The liquid crystal display apparatus of the present invention adopts a configuration including: the surface light source described above and a liquid crystal panel illuminated from the back of the liquid crystal panel by the surface light source.

### Advantageous Effect of the Invention

According to the present invention, the laser light emitting element is driven by a driving current on which a high frequency wave is superimposed, and the deflection element outputs incident laser light output in different directions, so that the present invention provides an advantage of changing the spread of angle of laser light upon output from the deflection element and brings about an effect as if the laser light vibrates. Consequently, speckle can be reduced without making a scatter plate and so on vibrate mechanically.

### BRIEF DESCRIPTION OF DRAWINGS

FIG. 1 is a configuration showing the laser light source according to Embodiment 1 of the present invention;

FIG. 2 is a circuit diagram showing a specific configuration of the semiconductor laser and the laser driving circuit of the laser light source according to the present embodiment;

FIG. 3 illustrates the optical output distribution of the laser element of the laser light source according to the present embodiment;

FIG. 4 is illustrates a longitudinal mode waveform showing the optical output distributions of the semiconductor laser of the laser light source according to the present embodiment;

FIG. 5 illustrates a driving waveform using direct current produced by the laser driving circuit of the laser light source according to the present embodiment;

FIG. 6 is a conceptual diagram showing the wavelength distribution of the laser light from the semiconductor laser when the semiconductor laser is driven with the direct current driving waveform of the laser light source according to the present embodiment;

FIG. 7 illustrates the situation where laser light outputted from semiconductor of the laser light source refracts at diffraction element according to the present embodiment;

FIG. 8 illustrates the driving waveform subjected to high frequency current superposition produced by the laser driving circuit of the laser light source according to the present embodiment;

FIG. 9 is a conceptual diagram showing the wavelength distribution of the laser light from the semiconductor laser when the semiconductor laser is driven with the driving waveform shown in FIG. 8;

FIG. 10 illustrates the distribution of angle in the laser light outputted from the diffraction element when the laser light with the wavelength distribution in FIG. 9 is incident upon the diffraction element;

FIG. 11 illustrates a driving waveform subjected to high frequency current superposition produced by the laser driving circuit of the laser light source according to Embodiment 2 of the present invention;

FIG. 12 illustrates a configuration of the surface light source according to Embodiment 3 of the present invention; and

FIG. 13 illustrates a configuration of the liquid crystal display apparatus using surface light source of the laser light source according to the present embodiment.

### BEST MODE FOR CARRYING OUT THE INVENTION

Now, embodiments of the present invention will be described in detail with reference to the accompanying drawings.

### Embodiment 1

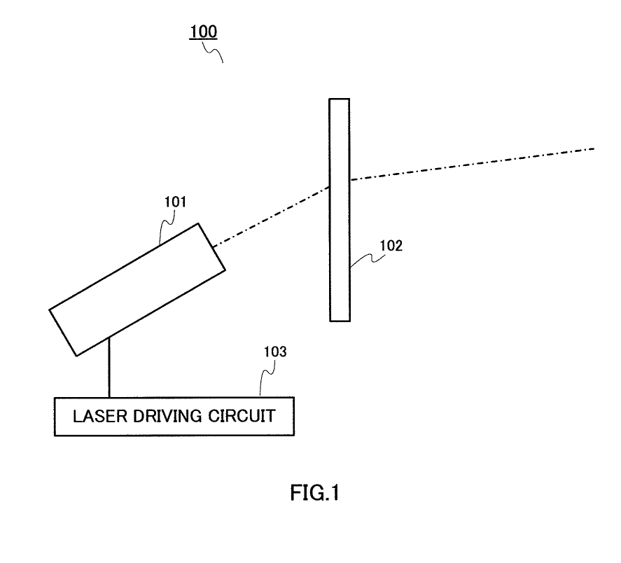

FIG. 1 shows a configuration of the laser light source according to Embodiment 1 of the present invention. The present embodiment is an example of applying a semiconductor laser for a light emitting element for a laser light source.

In FIG. 1, laser light source 100 is provided with semiconductor laser 101, diffraction element 102, which is placed at a predetermined angle on the optical path of the laser beam outputted from semiconductor laser 101, and laser driving circuit 103, which drives semiconductor laser 101 by electrical current.

Semiconductor laser 101 uses, for example, AlGaInP-based semiconductor laser and emits laser light with a uniform direction, phase and wavelength. The output of semiconductor laser 101 increases linearly with respect to the driving current. When the driving current exceeds a critical value (threshold current), laser operation is started and the optical output increases rapidly as the current increases.

Diffraction element 102 is an optical element assembling very small parallel slits or parallel grooves, and refracts the laser light incident from semiconductor laser 101 by the effect of diffraction and allows the laser light to pass. When laser light with different wavelengths is incident from semiconductor laser 101, diffraction element 102 refracts the incident laser light at various angles in accordance with wavelengths. When the range of wavelengths in the light from semiconductor laser 101 is broad due to high frequency current superposition (which will be explained later), diffraction element 102 refracts the light from semiconductor laser 101 at various angles in accordance with wavelengths to diffuse the direction of the light. Incidentally, although diffraction element 102 uses a transmission element that refracts and passes the incident laser beam, the diffraction element is not limited to a transmission type and may also be formed with a diffraction element of a reflection type.

Laser driving circuit 103 supplies the current in which a high frequency alternating current is superimposed on a direct current to semiconductor laser 101 and drives semiconductor laser 101. Superposition of a high frequency wave on the driving current of semiconductor laser 101 is referred to as “HFCS” (High Frequency Current Superposition). According to the present embodiment, a high frequency wave of approximately 200 MHz to 400 MHz is superimposed. This will be explained in detail later.

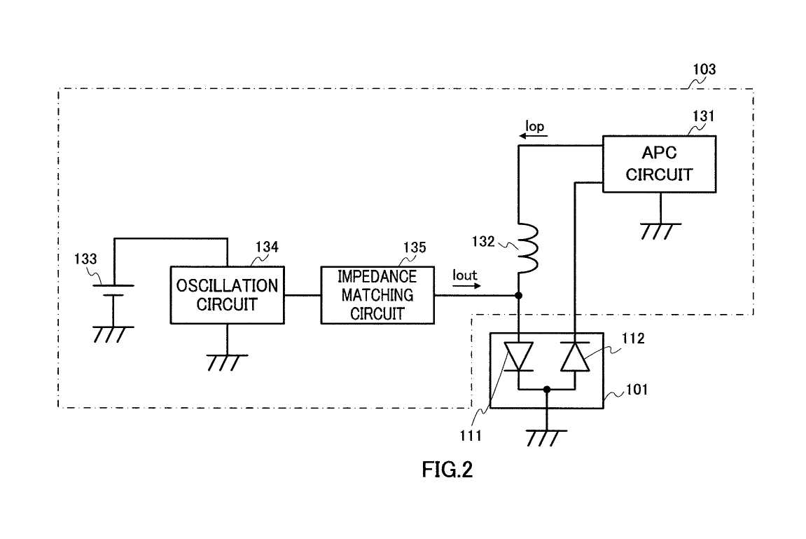

FIG. 2 is a circuit diagram showing a specific configuration of semiconductor laser 101 and laser driving circuit 103 above.

In FIG. 2, semiconductor laser 101 is formed with laser element 111 that radiates and emits laser light and back monitor light receiving element 112 that detects an optical output of laser element 111.

Laser element 111 uses a laser diode with a 50 W optical pulse output (100 ns pulse width), for example. Back monitor light receiving element 112 is placed in the same package of laser element 111 and detects the optical output of laser element 111.

Laser driving circuit 103 adopts a configuration having APC (Automatic Power Control) circuit 131, AC cut inductor 132, power supply 133, oscillation circuit 134 and impedance matching circuit 135.

APC circuit 131 supplies a direct current Iop to laser element 111. Based on a detecting signal in back monitor light receiving element 112, APC circuit 131 controls the direct current Iop so that the optical output of laser element 111 is constant.

AC cut inductor 132 cuts the alternating current component in the direct current Iop outputted from APC circuit 131.

Oscillation circuit 134 is supplied power from power supply 133 and produces a high frequency signal to be superimposed on the direct current Iop.

Impedance matching circuit 135 cuts the direct current component from the high frequency signal produced by oscillation circuit 134 and converts the output impedance of oscillation circuit 134 into an impedance of semiconductor laser 101. Impedance matching circuit 135 outputs an alternating current Iout, which is the high frequency signal produced by oscillation circuit 134 and having the direct current component cut off, upon the direct current Iop of APC circuit 131.

Power supply 133, oscillation circuit 134 and impedance matching circuit 135 form a high frequency current superposition circuit supplying the high frequency alternating current Iout to laser element 111, parallel to APC circuit 131 supplying the direct current Iop to laser element 111.

In the configuration above, the high frequency alternating current Iout from oscillation circuit 134 is superimposed on the direct current Iop from APC circuit 131, and the driving current subjected to high frequency current superposition drives laser element 111 of semiconductor laser 101. The optical output of laser element 111 is detected by back monitor light receiving element 112, and the detected signal is fed back to APC circuit 131. APC circuit 131 controls the optical output of laser element 111 such that the optical output of laser element 111 is constant.

When the driving current is greater than a threshold current, semiconductor laser 101 outputs the light in intensity matching the measure of the driving current. When a direct current is supplied, semiconductor laser 101 enters single-mode operation of oscillating a single mode, and, when a high frequency current superposition driving current in which a high frequency wave is superimposed on the driving current is supplied, semiconductor laser 101 enters multi-mode operation of oscillating multiple modes. Incidentally, a laser output has very close and discrete frequency components (that is, very narrow spectrums) in the spectral domain, and these discrete components are referred to as “modes.” They may also be referred to as “axial modes” or “longitudinal modes.”

The operations of laser light source 100 configured as above will be explained below.

The characteristics of semiconductor laser 101 will be explained first.

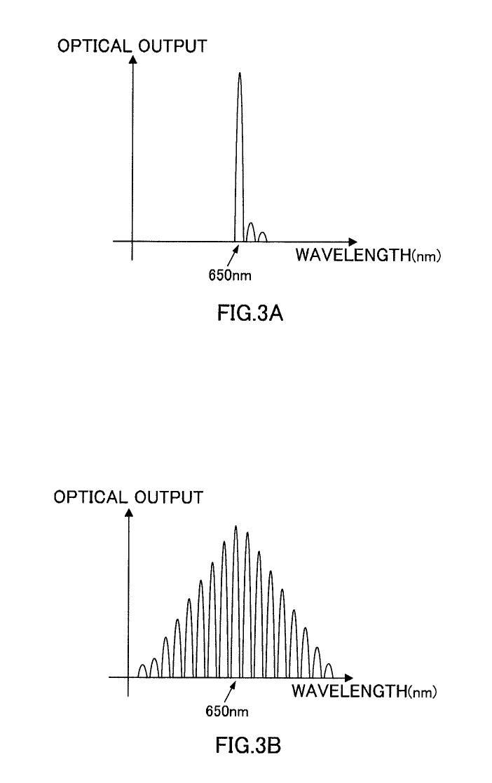

FIG. 3 illustrates the optical output distribution of laser element 111, showing longitudinal mode waveforms where the horizontal axis shows the wavelengths of laser light and the vertical axis shows the output of laser light.

The longitudinal mode waveform shown in FIG. 3A has a single mode, where laser light output is shown with a single wavelength mode, and the longitudinal mode waveform shown in FIG. 3B has multiple modes, where laser light output is shown with multiple wavelength modes. The wavelength interval where modes rise is determined by the size of laser element 111 and the wavelength where optical output is obtained (oscillation wavelength). For example, when the oscillation wavelength is 650 nm, the interval between modes is 0.1 nm.

To produce multiple modes from a single mode of laser element 111, there are a method of providing laser diodes in stripe structure, a self-pulsation production method of producing pulse oscillation of optical output using transient characteristics of laser light output, and a method of using high frequency current superposition. The first two methods utilize laser diodes structurally. The method of using high frequency current superposition is the same as the self-pulsation production method in using the transient characteristics of laser light output, and uses general-purpose laser diodes for laser element 111 and drives the laser diodes with a high frequency current using an oscillator to produce multimode characteristics.

The present embodiment employs a method of producing multiple modes from a single mode of semiconductor laser element 101 using the transient characteristics of laser light output by high frequency current superposition.

Next, producing laser light output with multiple modes by high frequency current superposition will be explained.

Referring to FIG. 2 described above, APC circuit 131 supplies the direct current Iop to laser element 111 of semiconductor laser 101. When the direct current Iop from APC circuit 131 is gradually increased from zero, the optical output of semiconductor laser 101 increases rapidly from the oscillation start current Ith (not shown) and increases linearly with respect to the increase of the direct current Iop.

On the other hand, oscillation circuit 134 is supplied power from power supply 133 and produces a high frequency signal to be superimposed on the direct current Iop. For example, the frequencies of the high frequency alternating current Iout are sinusoidal waves of 1 GHz, 250 MHz and 100 MHz, and the direct current Iop from APC current 131 is constant to match the oscillation start current Ith.

The high frequency alternating current Iout is superimposed on the direct current Iop from APC circuit 131, and the amplitude of the high frequency alternating current Iout swings plus and minus with respect to the direct current Iop. For this reason, the optical output of semiconductor laser 101 turns on and off at duty 50%, and longitudinal modes are produced, the number of which depends on the frequency f of the high frequency wave at the time. That is, at the oscillation start current Ith, which is an operating point, when a high frequency pulse is superimposed on the driving current, multiple longitudinal modes are produced. The number of these longitudinal modes depends on the frequency f of the superimposed high frequency wave. The frequency f of the high frequency wave focused upon here designates the period where semiconductor laser 101 keeps outputting light (hereinafter “ON duration”), especially when optical output starts rising, in the transient characteristics of laser light output of semiconductor laser 101. This ON duration is determined by the frequency f of the high frequency wave, and the frequency f of the high frequency wave determines the longitudinal mode waveform. The center wavelength in longitudinal modes and the interval between wavelengths where modes rise, are determined by the composition and the size of laser element 111 besides temperature variation. Accordingly, supposing that laser element 111 of certain characteristics is used, each longitudinal mode waveform by high frequency current superposition has a unique shape every laser element 111 used, if temperature variation is ignored. The number of these longitudinal modes increases when the ON duration (i.e. frequency f) is shorter, and, when the ON duration is longer, the longitudinal modes come close to a single mode (a single wavelength mode) and yet the intervals between wavelengths with a longitudinal mode waveform do not change. It naturally follows that, with laser element 111 of certain characteristics, there is an optimal value for the ON duration producing the greatest number of longitudinal modes, that is, for the frequency f of the high frequency wave for frequency current superpose. However, the more the high frequency current superposition waveform gets off the optimal ON duration (i.e. frequency f), the more the number of longitudinal modes decreases, and this in effect makes it difficult to produce multiple modes.

In FIG. 2, oscillation circuit 134 defines the oscillation start current Ith as the operating point and drives at duty 50%, so that the ON duration is determined from the frequency f of the high frequency wave from oscillation circuit 134.

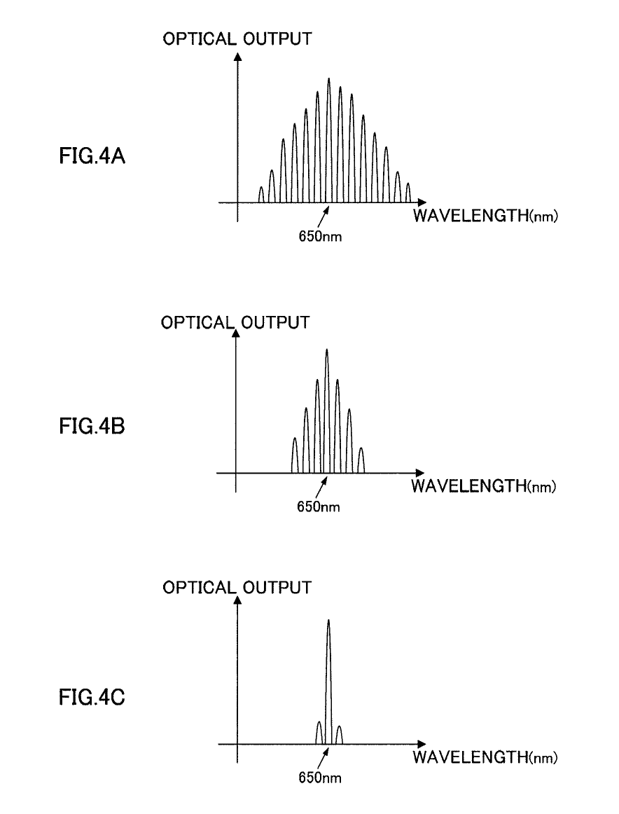

FIG. 4 illustrates a longitudinal mode waveform showing the optical output distributions of semiconductor laser light and the vertical axis is the output of laser light.

FIG. 4A shows a longitudinal mode waveform where the ON duration is 0.5 ns (f=1 GHz), FIG. 4B shows the longitudinal mode waveform where the ON duration is 2 ns (f=250 MHz) and FIG. 4C shows a longitudinal mode waveform where the ON duration is 5 ns (f=100 MHz). As shown in FIG. 4, when the ON duration is 0.5 ns, fourteen longitudinal modes appear, but, as the ON duration is longer, the number of longitudinal modes decreases, and so there is practically a single mode when the ON duration is 5 ns. Moreover, single-mode operation is continued when the ON duration is equal to or longer than 5 ns. This phenomenon results from the transient characteristics of when the optical output semiconductor laser 101 starts rising, and, even semiconductor laser 101 in single-mode operation oscillates multiple modes in the start, and the longitudinal mode waveform converges to an original single mode. Accordingly, if the state in the start of semiconductor laser 101 can be continued, semiconductor laser 101 for single-mode operation is able to produce multiple modes. In the present embodiment, the frequency of the high frequency wave in oscillation circuit 134 in FIG. 2 is set to several hundred MHz and the current of oscillation circuit 134 is superimposed on the direct current Iop of APC circuit 131, so that, upon a start of optical output of semiconductor laser 101, the direct current Iop swings plus and minus with respect to the operating point of the oscillation start current Ith by high frequency current superposition, and multi-mode operation continues by the transient characteristics of when the optical output starts rising.

Next, the relationships between the driving waveform produced by laser driving circuit 103, the wavelength distribution in the light produced from semiconductor laser 101 and the angle distribution of laser light outputted from diffraction element 102 will be explained.

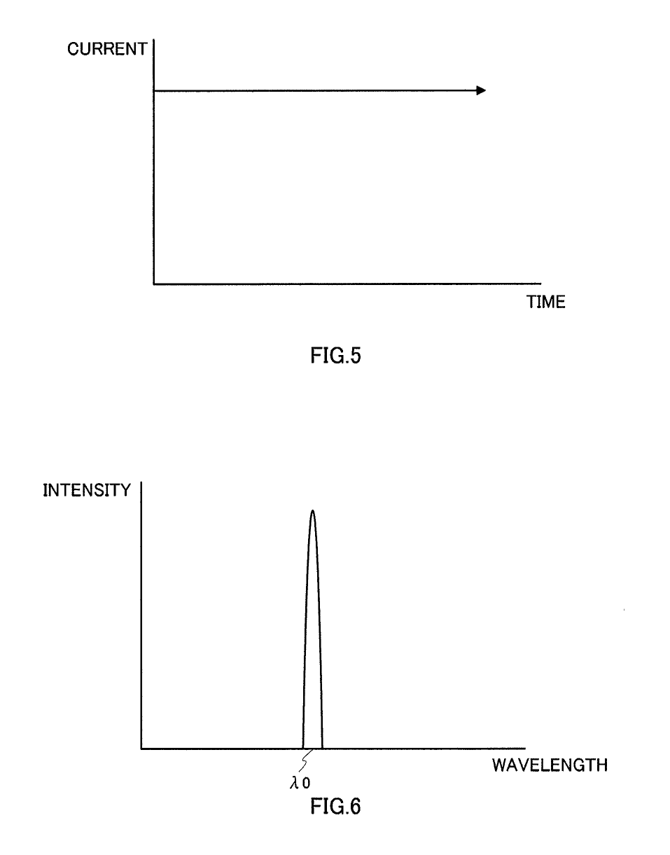

FIG. 5 illustrates the driving waveform using a direct current produced by laser driving circuit 103. This direct current is higher than the threshold current in semiconductor laser 101. In the circuit configuration in FIG. 2, APC circuit 131 supplies the direct current Iop to laser element 111 of semiconductor laser 101.

FIG. 6 is a conceptual diagram showing the wavelength distribution in laser light from semiconductor laser 101 when semiconductor laser 101 is driven with the direct current driving waveform shown in FIG. 5.

As shown in FIG. 6, when the driving current is a direct current, only a single wavelength (λ0) is outputted from semiconductor laser 101. The oscillating wavelength λ0 is 650 nm, for example.

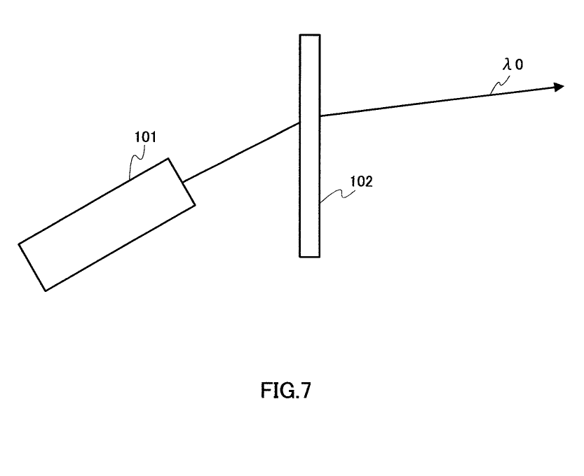

FIG. 7 illustrates the situation where laser light outputted from semiconductor laser 101 refracts at diffraction element 102.

At the emitting side of the optical output of semiconductor laser 101, diffraction element 102 is placed forming a predetermined angle with respect to the optical axis of the optical output of semiconductor laser 101. Diffraction element 102 refracts the laser light incident from semiconductor laser 101 by the effect of diffraction and changes the optical path of the optical output from semiconductor laser 101. The angle of refraction by diffraction element 102 depends on the wavelength of incident laser light and is determined by the wavelength of the incident laser light.

When laser light is outputted from semiconductor laser 101 with a single wavelength (λ0) as shown in FIG. 6, diffraction element 102 changes the optical path of the incident optical output of semiconductor laser 101 at the diffraction angle determined by wavelength (λ0). In this case, semiconductor laser 101 outputs laser light with a single wavelength (λ0), and the diffraction element 102 deflects the incident laser light with a single wavelength to output the laser light in a fixed direction.

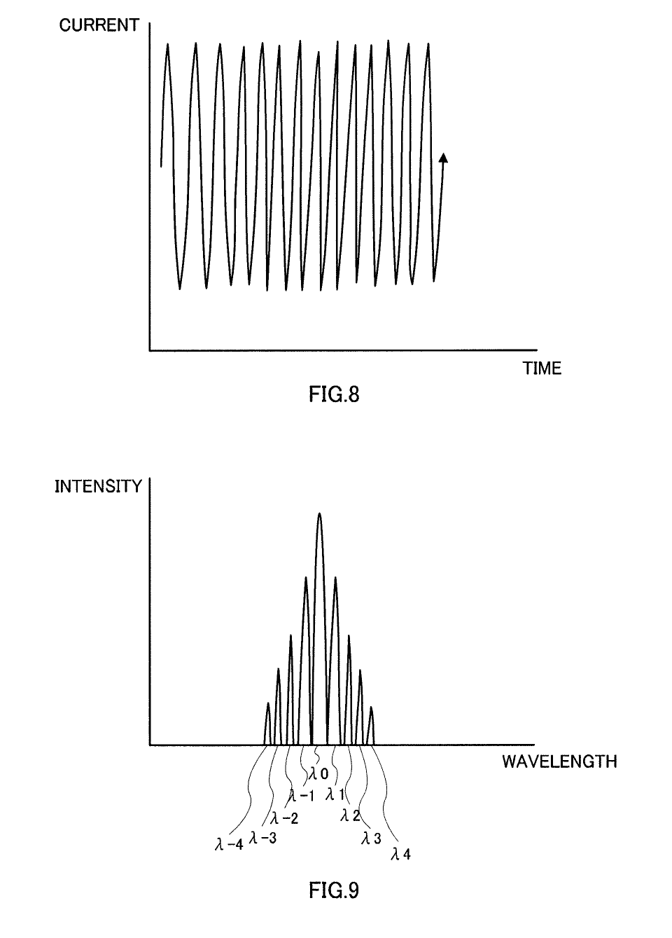

FIG. 8 shows a driving waveform subjected to high frequency current superposition produced by laser driving circuit 103. FIG. 8 shows a driving current where a high frequency alternating current is superimposed on the direct current shown in FIG. 5. In the circuit configuration in FIG. 2, the high frequency alternating current Iout from oscillation circuit 134 is superimposed on the direct current Iop from APC circuit 131, and laser element 111 of semiconductor laser 101 is driven by the driving current subject to high frequency current superposition.

FIG. 9 is a conceptual diagram showing the wavelength distribution in laser light from semiconductor laser 101 when semiconductor laser 101 is driven with the driving waveform shown in FIG. 8.

As shown in FIG. 9, semiconductor laser 101 enters multi-mode operation by high frequency current superposition, so that laser light with other wavelengths λ-4 to λ-1 and λ1 to λ4 around the center wavelength λ0 is also outputted from semiconductor laser 101. In multi-mode operation, for the oscillation wavelengths, for example, wavelengths (λ-4 to λ-1 and λ1 to λ4), in which the interval between modes with respect to the center wavelength (λ0) is 0.1 nm, are outputted.

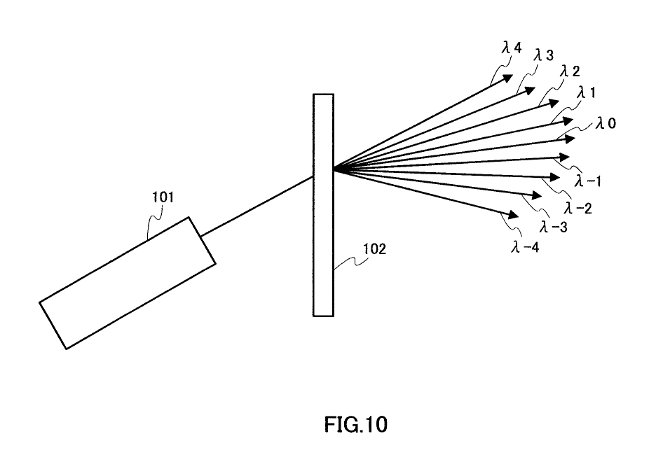

FIG. 10 illustrates the distribution of angle in the laser light outputted from diffraction element 102 when laser light with the wavelength distribution shown in FIG. 9 is incident upon diffraction element 102. Diffraction element 102 refracts the laser light incident from semiconductor laser 101 by the effect of diffraction. When laser light with differing wavelengths is incident from semiconductor laser 101, diffraction element 102 refracts the incident laser light at various angles in accordance with wavelengths.

The laser light incident from semiconductor laser 101 has longitudinal mode waveforms with wavelengths λ-4 to λ-1 and λ1 to λ4 around the center wavelength λ0, by producing multiple modes. Diffraction element 102 refracts the laser light incident from semiconductor laser 101 at various angles in accordance with wavelengths (λ-4 to λ-1, λ0 and λ1 to λ4) to output the laser light in different directions. Accordingly, the optical output from semiconductor laser 101 is outputted from diffraction element 102 at various angles in accordance with wavelengths of λ-4 to λ4.

As described above, the present embodiment places diffraction element 102 that refracts incident laser light at various angles in accordance with wavelengths, at the emitting side of the optical output of semiconductor laser 101, drives semiconductor laser 101 by a driving current on which a high frequency wave is superimposed and receives incident laser light output to diffraction element 102 with multiple wavelength modes, so that it is possible to output incident laser light output from diffraction element 102 in different directions. This makes it possible to form laser light with a range of emission angles of diffraction element 102 having passed diffraction element 102, out of laser light output with a range of wavelengths having multiple wavelength modes, so that speckle can be reduced by diffusing the path of laser light. Speckle can be reduced by diffusing light intensity distribution in illumination areas. By switching between performing high frequency current superposition and not performing high frequency current superposition over time, or by changing the specifications of high frequency current superposition, speckle can be reduced further.

Moreover, without vibrating the components mechanically, an effect is brought about as if laser light which can reduce speckle vibrates, so that it is possible to enable lower cost and higher reliability without resulting in upsizing and deterioration of the apparatus.

### Embodiment 2

A case has been described above with Embodiment 1 where laser light is outputted with multiple modes by high frequency current superposition. Now, an example will be described with Embodiment 2 where the amplitude of a high frequency wave is modulated by a low frequency.

The hardware configuration of the laser light source according to Embodiment 2 of the present invention is the same as in FIGS. 1 and 2, and so the description thereof will be omitted.

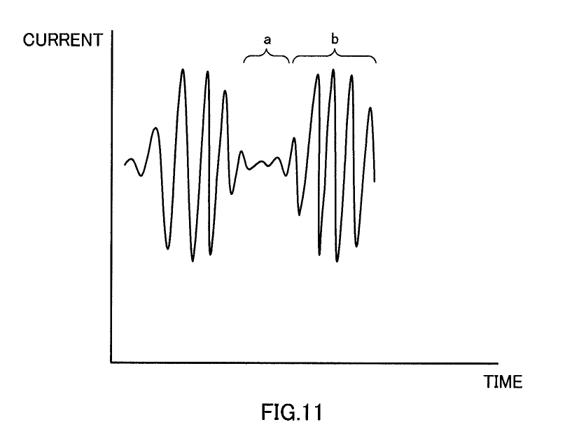

FIG. 11 illustrates a driving waveform subjected to high frequency current superposition produced by laser driving circuit 103 of the laser light source according to Embodiment 2 of the present invention.

Laser driving circuit 103 of the laser light source according to Embodiment 2 of the present invention modulates the amplitude of a high frequency wave superimposed on a direct current using a low frequency, and superimpose the modulated high frequency wave as the driving current on a direct current. In FIG. 2, oscillation circuit 134 produces a high frequency signal with an amplitude that changes with time, superimposes the high frequency signal with an amplitude that changes with time as the driving current, on the direct current Iop from APC circuit 131, and laser element 111 of semiconductor laser 101 is driven by the driving current subjected to high frequency current superposition.

As shown in FIG. 11, semiconductor laser 101 emits the laser light with a single wavelength (λ0) shown in FIG. 6 in the period “a” in which the amplitude of the high frequency wave is small, and emits the laser light with multiple longitudinal mode wavelengths (λ-4 to λ-1, λ0 and λ1 to λ4) shown in FIG. 9 in the period “b” in which the amplitude of the high frequency wave is large. Consequently, in the period “a” in which the amplitude of the high frequency wave is small, the light from diffraction element 102 does not spread and travels in a fixed direction as shown in FIG. 7, and, in the period “b” in which the amplitude of the high frequency wave is large, the light spreads and travels in different directions as shown in FIG. 10.

In this way, the present embodiment modulates the amplitude of a high frequency wave using a low frequency and superimposes the modulated high frequency wave on a direct current, so that, for the same reason as with Embodiment 1, it is possible to diffuse the path of laser light and reduce speckle. The present embodiment anticipates an advantage of further reducing this speckle. When human eyes observe an area illuminated by laser light with severe interference, speckle is produced. Accordingly, if the influence of interference can be diffused in time or in space, for human eyes, speckle can be reduced. Embodiment 1 reduces speckle by diffusing the path of laser light in space by high frequency current superposition. By making variations adequately in high frequency current superposition over time instead of performing high frequency current superposition constantly, diffusion in time makes it possible to reduce speckle.

Although with the present embodiment, the amplitude of a high frequency wave is changed in time using a low frequency, for the reasons described above, a case is also possible where the period in which a high frequency wave is superimposed and the period in which a high frequency wave is not superimposed are changed in time, and the same advantage can be achieved.

### Embodiment 3

Now, a surface light source using laser light source 100 and a liquid crystal display apparatus using this surface light source will be described with Embodiment 3.

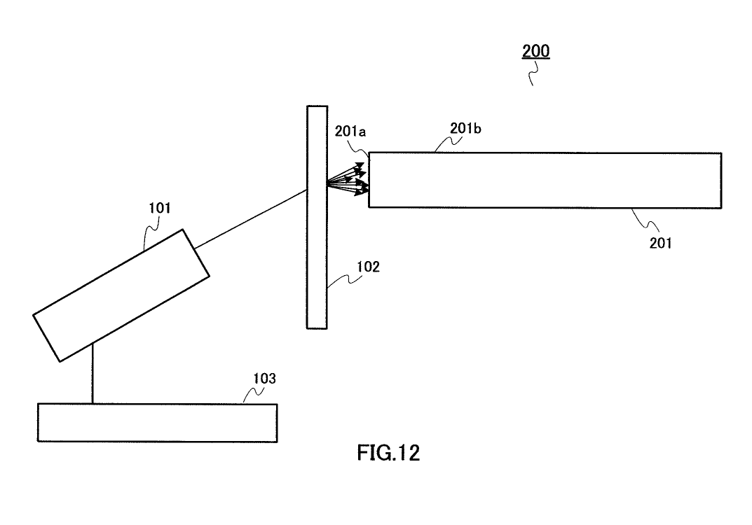

FIG. 12 illustrates the configuration of the surface light source according to Embodiment 3 of the present invention. The same reference numerals are assigned to the same parts as in FIG. 1.

In FIG. 12, surface light source 200 is provided with laser light source 100 and light guide plate 201, light guide plate 201 receiving incident laser light outputted from diffraction element 102 of laser light source 100 and outputting planar light.

From end plane 201a, light guide plate 201 receives the incident laser light outputted from diffraction element 102 and outputs a planar laser light to top plane 201b. The locations for installing light guide plate 201 and diffraction element 102 will be described next. Light guide plate 201 is installed in a location where the laser light outputted with different angle distributions is incident approximately uniformly into the thickness direction of end plane 201a in light guide plate 201.

The laser beam incident in end plane 201a of light guide plate 201 is multiple reflected inside light guide plate 201, and thereafter reflected by micro-reflection structures (not shown) arranged in a distributed manner in light guide plate 201 and outputted from top plane 201b. Semiconductor laser 101 is driven by a driving current subjected to high frequency current superposition and diffraction element 102 refracts the incident laser light at various angles in accordance with wavelengths and inputs the laser light to end plane 201a of light guide plate 201, so that the laser light outputted from diffraction element 102 is inputted in the thickness direction of light guide plate 201 with different angle distribution. The laser light incident into end plane 201a of light guide plate 201 with different angle distribution is multiple reflected in various optical paths, reflected by various micro-reflection structures and outputted to top plane 201b, so that a surface light source without speckle can be realized.

Moreover, as described above with Embodiment 2, by making variations in high frequency current superposition over time would make it possible to realize a surface light source without speckle.

To diffuse the direction of light to the width direction of light guide plate 201, for example, it is possible to reflect laser light by a mirror with a reflecting surface positioned at an angle with respect to the width direction of the laser light to increase the width of the laser light and inject the laser light in the end plane.

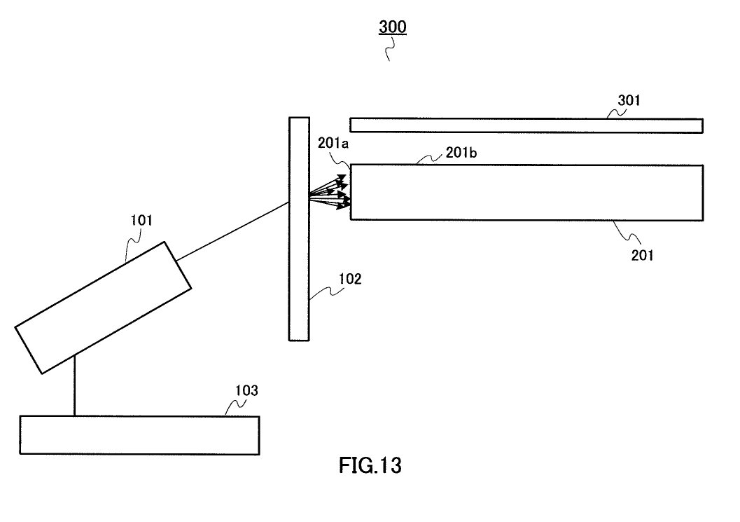

FIG. 13 illustrates the configuration of a liquid crystal display apparatus using surface light source 200 above.

In FIG. 13, liquid crystal display apparatus 300 adopts a configuration having surface light source 200 and liquid crystal panel 301 using surface light source 200 as a backlight.

The back of liquid crystal panel 301 is illuminated by light emitted from light guide plate 201. This illuminating light uses laser light, so that the polarizing directions are uniform and this illuminating light is efficient and produces great optical output from small areas. Furthermore, as described above, there is no speckle, so that it is possible to realize a liquid crystal display apparatus that enables excellent color reproduction.

Consequently, a compact backlight can be formed for a large screen display use and power saving of a backlight can be provided. Furthermore, as described above, there is no speckle, so that it is possible to realize a liquid crystal display apparatus that enables excellent color reproduction.

The laser light source of the present invention has a laser, a diffraction element for refracting an optical light emitted from the laser at different angles depending on wavelength and a laser driving circuit for driving the laser, and, according to the laser light source of the present invention, a high frequency wave is superimposed on the driving current with which the driving circuit drives the laser.

By this means, it is possible to make laser light with a range of wavelengths into a beam with a range of emission angles after passage of a diffraction element, and reduce speckle.

Moreover, the laser light source of the present invention modulates the amplitude of a high frequency wave superimposed on a driving current with a lower frequency.

By this means, although the center wavelength of beams emitted from a laser is the same, it is possible to reduce speckle further by switching a wideband beam with a relatively wide range of wavelengths and a narrowband beam with a relatively narrow range of wavelengths with time.

The laser light source of the present invention has a laser, a diffraction element and a driving circuit for the laser, and, according to the laser light source of the present invention, a high frequency wave is superimposed in the driving circuit and an amplitude of a high frequency wave is modulated with a lower frequency, so that the laser light source of the present invention provides an advantage of changing the spread of angle of beams upon emission from the diffraction element and brings about an effect as if beams vibrate, thereby reducing speckle.

The description above is examples of preferred embodiments of the present invention, and the scope of the present invention is not limited to these.

For example, other lasers than a semiconductor laser may be used and provide the same advantages as the present invention. Although examples have been shown with the embodiments where a diffraction element is added, the present invention is not limited to this. The diffraction element may be replaced with a deflection element such as a lens element and a phase difference element having wavelength dependence (diffusion characteristics) and refracting or reflecting laser light at different angles depending on wavelengths.

Moreover, although names such as “laser light source,” “surface light source” and “liquid crystal display apparatus” have been used with the embodiments for ease of explanation, other such as “surface light source apparatus” and “backlight” are equally applicable.

The present application is based on Japanese Patent Application No. 2006-242439, filed on Sep. 7, 2006, the entire content of which is expressly incorporated by reference herein.

### INDUSTRIAL APPLICABILITY

The laser light source, surface light source and liquid crystal display apparatus of the present invention provide an advantage of producing light without speckle from a laser, and are suitable for use in liquid crystal display monitors and liquid crystal display televisions that especially require color reproduction.

1. A laser light source, comprising:
a light emitting element that emits a laser light;
a deflection element that operates relying upon wavelength and that refracts or reflects the laser light emitted from the light emitting element at various angles in accordance with wavelengths; and
a driving circuit that drives the light emitting element by a driving current in which a high frequency wave is superimposed on a direct current.

2. The laser light source according to claim 1, wherein the driving circuit modulates an amplitude of the high frequency wave using a low frequency current and superimposes the modulated high frequency wave on the direct current.

3. The laser light source according to claim 1, wherein the driving circuit uses a driving current having a period where the high frequency wave is superimposed on the direct current and a period where the high frequency wave is not superimposed on the direct current.

4. A surface light source comprising:
a laser light source according to claim 1; and
a light guide plate that inputs the laser light outputted from the deflection element and outputs planar light.

5. The surface light source according to claim 4, wherein the deflection element changes the incident direction to the light guide plate of the laser light outputted from the light emitting element, to a thickness direction of the light guide plate.

6. A liquid crystal display apparatus comprising:
a surface light source according to claim 4; and
a liquid crystal panel illuminated from the back of the liquid crystal panel by the surface light source.
